(19) United States
(12) Patent Application Publication
(10) Pub. No.: US 2015/0270694 A1
(43) Pub. Date: Sep. 24, 2015

(54) WIRE RETAINER

(71) Applicant: Richard F. Bailey, Gambrills, MD (US)

(72) Inventor: Richard F. Bailey, Gambrills, MD (US)

(21) Appl. No.: 14/220,737

(22) Filed: Mar. 20, 2014

(51) Int. Cl. H02G 3/30; H02G 3/08

(52) U.S. Cl. CPC H02G 3/24; H02G 3/08

(57) ABSTRACT

A wire retainer may be disclosed. The wire retainer may include a base support having a front face and a back face. The base support may have a plurality of middle prongs disposed from a face of the base. The base may also have a first end portion and a second end portion. The middle prongs and end portions may create a plurality of wire retaining channels. The base support may also have at least one fastening bore through the faces of the base support.

### BACKGROUND

Main distribution panels and other wire panel boards often have a plurality of wires or cables running to or from them. It is important to arrange the wires in a manner that certain wires or cables can easily be manipulated without disrupting the rest of the wires. When running wires or cables, extra length is often provided to give slack in the line to prevent pressure on the connectors and to allow manipulation of the wire or cable. Wires or cables running to the same or nearby conduits often become mixed or entangled. Also, there is often a need to track the path of a specific wire or cable which can be problematic and time consuming, especially determining the appropriate wire when several are present. It can be difficult to organize, secure, and effectively label these wires or cables.

Often, the best solution is to staple or strap the wires or cables in a desired orientation to the surface the distribution panel is mounted on. This allows a technician to determine the appropriate wire for manipulation when changing connections, replacing, or removing wires. However, stapling and strapping the wires or cables is time intensive and though it helps with organization, it makes it difficult to remove or manipulate the wires once found.

### SUMMARY

A wire retainer may be disclosed. The wire retainer may include a base support having a front face and a back face. The base support may have a plurality of middle prongs disposed from a face of the base. The base may also have a first end portion and a second end portion. The middle prongs and end portions may create a plurality of wire retaining channels. The base support may also have at least one fastening bore through the faces of the base support.

### BRIEF DESCRIPTION OF THE DRAWINGS

FIG. 1 is an exemplary top-front isometric view of a wire retainer.

FIG. 2 is an exemplary front view of a wire retainer.

FIG. 3 is an exemplary top view of a wire retainer.

FIG. 4 is a side view of a first embodiment of a wire retainer.

FIG. 5 is a front view of a second embodiment of a wire retainer.

FIG. 6 is a top view of a second embodiment of a wire retainer.

FIG. 7 is a side view of a first embodiment of a wire retainer.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention,” “embodiments,” or “invention” do not require that all embodiments of the invention include the discussed feature, advantage or mode of operation.

Generally referring to the accompanying drawings, a wire retainer may be formed in any of a variety of manners and may be used in any of a variety of situations. A wire retainer can be made of a material that is not electrically conductive. [REQUEST FOR CLIENT COMMENT: MAY BE HELPFUL TO ADD CONTENT SPECIFIC TO THE PREFERRED MATERIAL TO BE USED FOR THE WIRE RETAINER (IF MOLDED PLASTIC, WHAT TYPE OF MOLDED PLASTIC?). ALSO WOULD INCLUDE CONTENT EXPLAINING PARTICULAR ADVANTAGES ASSOCIATED WITH CHOICE OF MATERIAL] An exemplary embodiment may appear similar to device 100, although other forms and designs are envisioned.

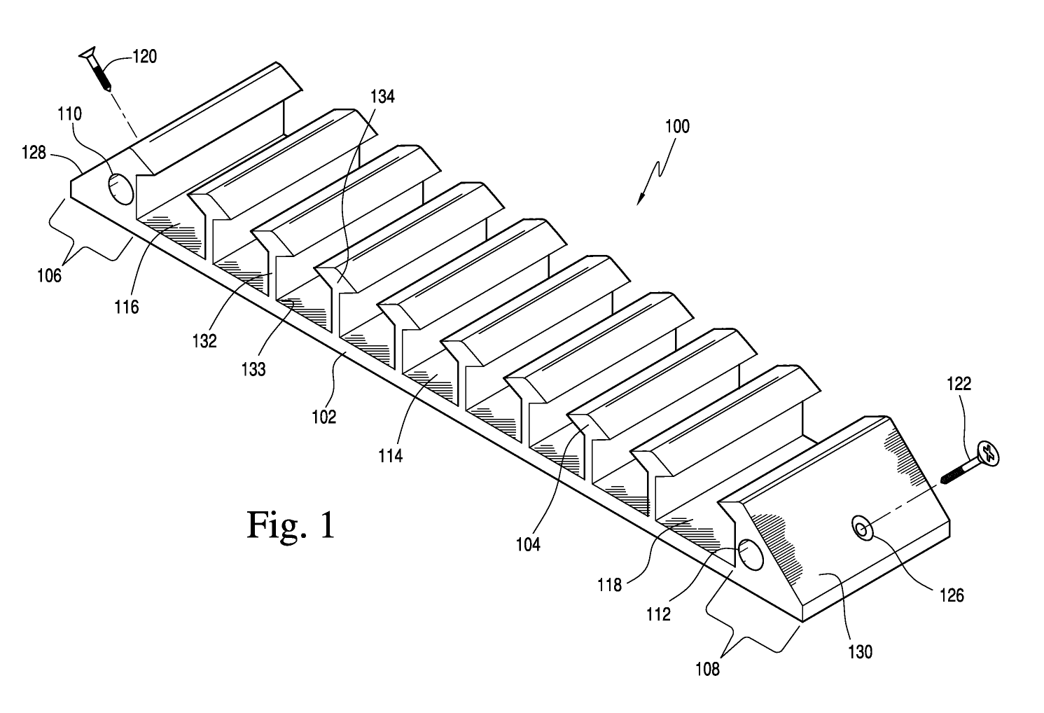

Referring now to exemplary FIG. 1, a top-front isometric view of a wire retainer 100 may be shown. Generally, the wire retainer 100 can be used to neatly and safely organize a plurality of elongate elements, such as wires, cables, and pipes, which are connected to a main distribution location or device. Additionally, the wire retainer 100 may also aid in maintaining proper identification of the retained elongate elements. An exemplary situation where the wire retainer 100 might be used is in conjunction with an electrical panel, for example a main distribution panel (MDP), to which one or more electrical wires are connected. Another exemplary situation where the wire retainer might be used is in conjunction with a network hub, to which one or more network cables are connected. Wire retainer 100 may also be used along the path of a single or a plurality of wires or cables to maintain a desired path and orientation.

As shown in the exemplary Figures, the wire retainer 100 may be an autonomous assembly that includes a base support 102, middle prongs 104, a first end portion 106 and a second end portion 108. The first end portion 106 may have a first grounding bore 110. The second end portion 108 may have a second grounding bore 112. Elongate elements can be received into channels defined by the base support 102, middle prongs 104, a first end portion 106 and a second end portion 108 such that the elongate elements are held substantially perpendicular to the lengthwise plane of the base support 102.

Further referring to FIG. 1, middle prongs 104 and base support 102 can define middle channels 114 that may run substantially perpendicular to the lengthwise plane of the base support 102. The quantity of middle prongs 104 and middle channels 114 can vary. Additionally, middle prongs 104 may be variably spaced along the base support 102 such that middle channels 114 have variable widths. The first end portion 106 and the middle prong 104 nearest to the first end portion 106 can define a first end channel 116. Similarly, the second end portion 108 and the middle prong 104 nearest to the second end portion 108 can define a second end channel 118. As with middle channels 114, the first end channel 116 and second end channel 118 may have variable widths. For example, as shown in FIG. 1, first end channel 116 and second end channel 118 can be wider than the middle channels 114. Larger widths can allow end channels 116 and 118 to retain larger gauge elements than the middle channels 114. Retaining larger gauge elements within end channels 116 and 118 can provide extra protection for the smaller gauge elements retained by the middle channels 114, which can be more susceptible to damage or complete severance than larger gauge elements upon the impact of a destructive force.

Middle prongs 104 can have a shaft 132, an inner end 133, and a head 134. The shaft may have a width that affords the prongs 104 to have sufficient flexibility to allow for the wire retainer to receive elongate elements within channels 114, 116, and 118. The inner ends 133 may be tapered out wider than the shafts 132. Tapered inner ends 133 can provide additional foundational support to the middle prongs 104. Also, tapered inner ends 133 can provide middle prongs 104 with heightened resiliency to deformation after repetitious deflection of the prongs 104 as elements are inserted or removed from wire retainer 100. Furthermore, tapered inner ends 133 can help to maintain an elongate element in the middle of the channel 114, 116, or 118 within which the elongate element is retained.

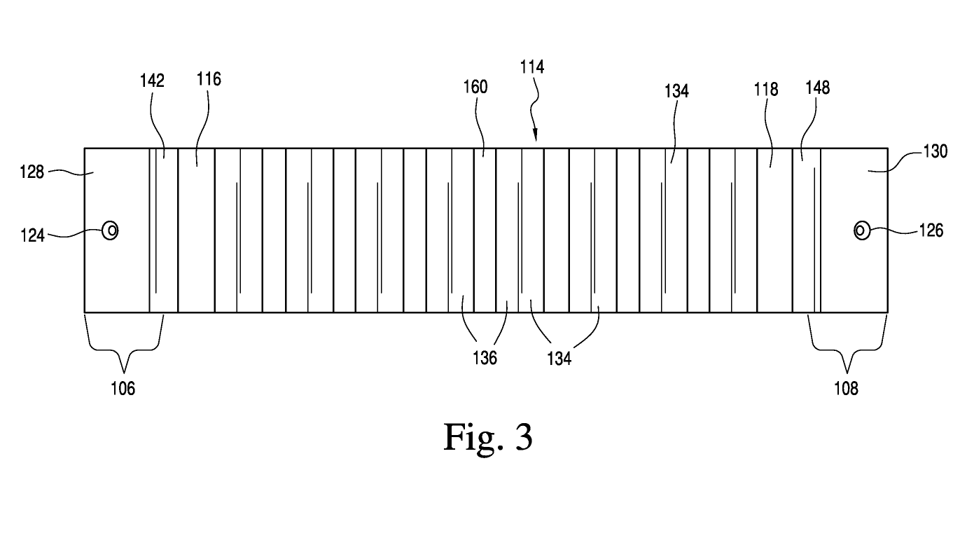

In addition to showing exemplary wire retainer 100, the exemplary Figures may also show a first end fastener 120 and a second end fastener 122. Fasteners 120 and 122 may be individual fastening elements such as screws, nails, staples or the like. Where first end fastener 120 is a screw or nail, the cross sectional diameter of a first end fastener bore 124 (see exemplary FIG. 3) may be complimentary to the diameter of the middle portion of the first fastener 120. Similarly, where second end fastener 122 is a screw or nail, the cross sectional diameter of a second end fastener bore 126 may be complimentary to the diameter of the middle portion of the second fastener 122. First end fastener bore 124 may be disposed from the first end portion front face 128, through the first end portion 106. Similarly, second end fastener bore 126 may be disposed from the second end portion front face 130 (see FIG. 3), through the second end portion 108. First fastener 120 can be frictionally driven into first end fastener bore 124 to couple first end portion 106 to the supporting surface. Second fastener 122 can be frictionally driven into second end fastener bore 126 to couple second end portion 108 to the supporting surface. While not shown in FIG. 1, a wire retainer 100 may have more than one first end fastener bore 124 and more than one second end fastener bore 126 to allow for the use of multiple first end fasteners 120 and multiple second end fasteners 122 and thereby providing additionally secure coupling for the first end portion 106 and the second end portion 108 with the supporting surface. A supporting surface may be a wall or wall stud, or as desired. Commonly, the wire retainer 100 can be positioned on a portion of a wall or wall stud that is directly adjacent or near to a main distribution location or device, such as a main distribution panel or network hub.

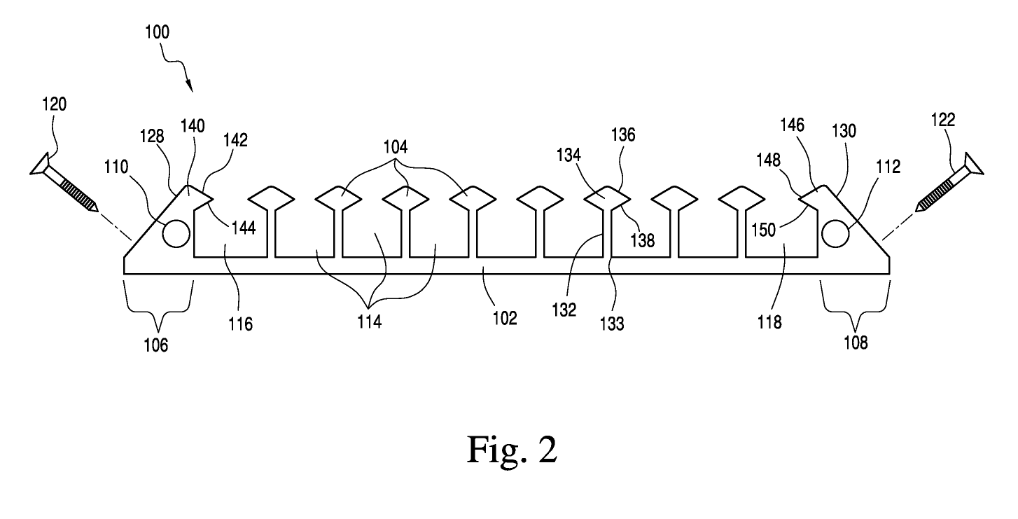

Referring now to exemplary FIG. 2, a front view of a wire retainer 100 may be shown. The first end portion 106 can have a first end grounding bore 110. First grounding bore 110 can extend from the first end portion front face, through the first end portion 106, and to the first end portion rear face. The first end ground bore 110 and the first end fastener bore 124 (see exemplary FIG. 3) can be disposed within the first end portion 106 such that the bores 110 and 124 do not intersect. Also, a second end grounding bore 112 can extend from the second end portion front 156, through the second end portion 108, and to the second end portion rear face. The second end grounding bore 112 and the second end fastener bore 126 (see exemplary FIG. 3) can be disposed within the second end portion 108 such that the bores 112 and 126 do not intersect. Grounding bores 110 and 112 can completely retain an elongate element, such as a grounding wire or a neutral wire. By surrounding the entire circumference of an elongate element, grounding bores 110 and 112 can allow the wire retainer 100 to provide extra security for certain elongate elements that are critical to the functionality and safety of a network. For example, where the wire retainer is applied to retain electrical wires connected to a main distribution panel, a grounding wire and/or a neutral wire that are connected to the system to protect against faults may be retained within grounding bores 110 and 112.

The head 134 of each middle prong 104 may have a profile that is substantially diamond shaped. The slanted outer faces 136 of the heads 134 can guide an elongate element towards the middle of a channel 114, 116 or 118 as it is pushed into the wire retainer 100 such that minimal deflection of the prongs 114 is required for the elongate element to be received and retained in the desired channel 114, 116 or 118. The slanted inner faces 138 provide additional contact area between the wire retainer 100 and a retained elongate element to allow for a more secure retaining. Also, the slanted inner faces 138 can guide the elongate element towards the middle of a channel 114, 116 or 118 as it is pulled out of the wire retainer 100 such that minimal deflection of the prongs 114 is required when the elongate element is removed from a channel 114, 116 or 118.

First end portion 106 can have a first end flange 140, with dimensions that are complimentary to the heads 134. First end flange 140 can have a first end flange outer face 142 and a first end flange inner face 144. Second end portion 108 can have a second end flange 146, with dimensions that are complimentary to the heads 134. Second end flange 146 can have a second end flange outer face 148 and a second end flange inner face 150. Similar to the heads 134, first end flange 140 and second end flange 146 can provide elongate element guiding and securing functions.

Exemplary FIG. 3 may show top view of wire retainer 100. Wire retainer 100 may have a first end portion front face 128 including a first end fastener bore 124 and a second end portion front face 130 including a second end fastener bore 126. Also, slanted outer faces 136 of the heads 134, first end flange outer face 142, and second end flange outer face 148 may be shown. Parts of base support outer face portions 160 that are not covered by heads 134 or flanges 140 and 146 may be shown as well. While not shown in exemplary FIG. 3, base support outer face portions may have visible labels that can allow the wire retainer 100 to aid in maintaining proper identification of the retained elongate elements. Labels may be numbers, letters, symbols, shapes, colors, or the like.

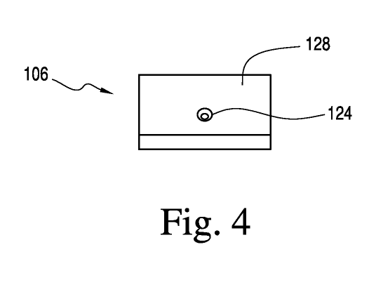

Exemplary FIG. 4 may show a side-view of first end portion 106 of wire retainer 100.

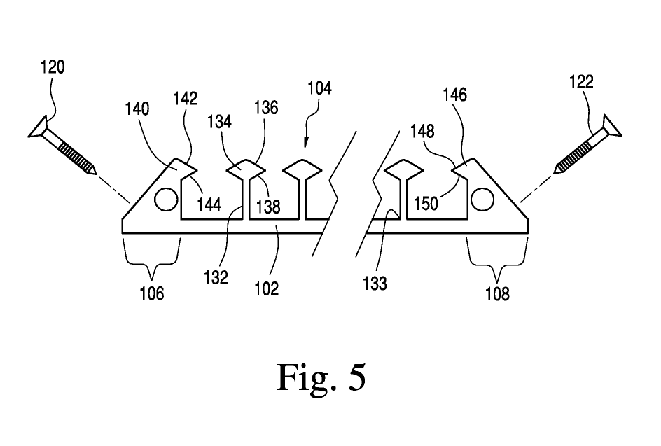

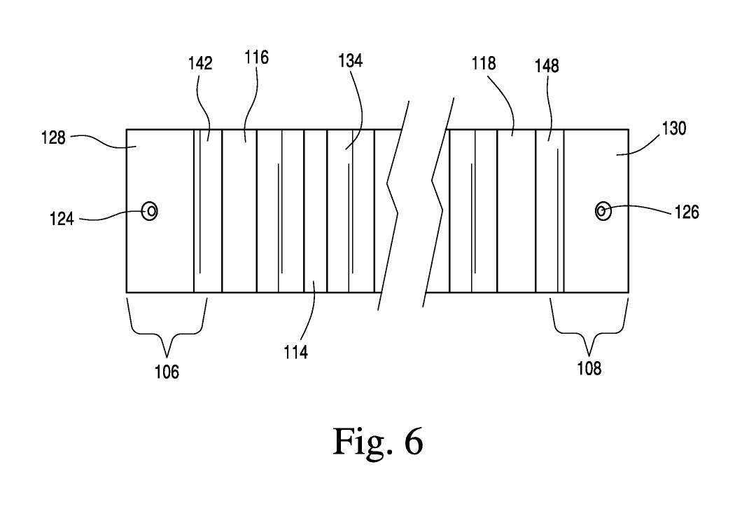

Exemplary FIGS. 5 and 6 may show a second embodiment of the invention. These exemplary Figures may show that the length of a wire retainer according to this invention may be of variable length and may include one, many, or no middle prongs 104.

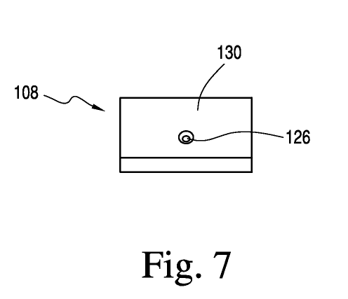

Exemplary FIG. 7 may show a side-view of second end portion 108 of wire retainer 100.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A wire retainer, for retaining a plurality of elongate elements that connect to a main distribution device comprising:
a substantially elongated base support, having a back face and a front face;
a plurality of middle prongs disposed from the front face of the substantially elongated base support, creating a plurality of wire retaining channels between the middle prongs;
and a first end portion forming an end of the substantially elongated base support and a second end portion forming an end of the substantially elongated base support, wherein the first end portion and a middle prong proximate the first end portion create a wire retaining channel and the second end portion and a middle prong proximate the second end portion create a wire retaining channel.

2. The wire retainer of claim 1, further comprising at least one grounding bore for retaining a neutral wire.

3. The wire retainer of claim 1, further comprising at least one fastening bore passing through the front face, the base support, and the back face

4. The wire retainer of claim 1, further comprising flanges disposed on an end of the middle prongs opposite the front face of the base support.

5. The wire retainer of claim 1, further comprising varying sizes of wire retaining channels.

6. The wire retainer of claim 1, further comprising label space disposed proximate each wire retaining channel.

7. The wire retainer of claim 1, further comprising tapered ends of middle prongs and end portions proximate the front face of the base support to assist in seating wires in the wire retaining channels and to reinforce the middle prongs and the end portions.
